(19) United States
(12) Patent Application Publication
(10) Pub. No.: US 2017/0092162 A1
(43) Pub. Date: Mar. 30, 2017

(54) Display Mounting System

(71) Applicant: John Skarvellis, Rochelle Park, NJ (US)

(72) Inventor: John Skarvellis, Rochelle Park, NJ (US)

(21) Appl. No.: 14/871,375

(22) Filed: Sep. 30, 2015

(51) Int. Cl. G09F 7/18; F16M 13/02

(52) U.S. Cl. CPC G09F 7/18; F16M 13/022; G09F 2007/1817; G09F 2007/1856

(57) ABSTRACT

A display mounting system includes a plurality of display mounts. Each of the display mounts has an outer surface, an inner surface, a first side edge, a second side edge, a top side and a bottom side. The display mounts each comprising a resiliently compressible material. The plurality of the display mounts is pivotally coupled together and positionable such that the inner surfaces form a closed loop to receive and frictionally engage a post. An outer two of the display mounts is defined. A coupler releasably couples the first side edge of the one of the outer two of the display mounts to the second side edge of the other one of the outer two of the display mounts to releasably retain the display mounts on the post.

### BACKGROUND OF THE DISCLOSURE

### Field of the Disclosure

The disclosure relates to display mounts and more particularly pertains to a new display mount for displaying advertising on a pole or post type structure so that the advertising is viewable from all angles around the pole.

### SUMMARY OF THE DISCLOSURE

An embodiment of the disclosure meets the needs presented above by generally comprising a plurality of display mounts. Each of the display mounts has an outer surface, an inner surface, a first side edge, a second side edge, a top side and a bottom side. The display mounts each comprising a resiliently compressible material. The plurality of the display mounts is pivotally coupled together and positionable such that the inner surfaces form a closed loop to receive and frictionally engage a post. An outer two of the display mounts is defined. A coupler releasably couples the first side edge of the one of the outer two of the display mounts to the second side edge of the other one of the outer two of the display mounts to releasably retain the display mounts on the post.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a display mounting system according to an embodiment of the disclosure.

FIG. 2 is a bottom view of an embodiment of the disclosure.

FIG. 3 is a front view of an embodiment of the disclosure.

FIG. 4 is a top view of an embodiment of the disclosure.

FIG. 5 is a perspective in-use view of an embodiment of the disclosure.

### DESCRIPTION OF THE PREFERRED EMBODIMENT

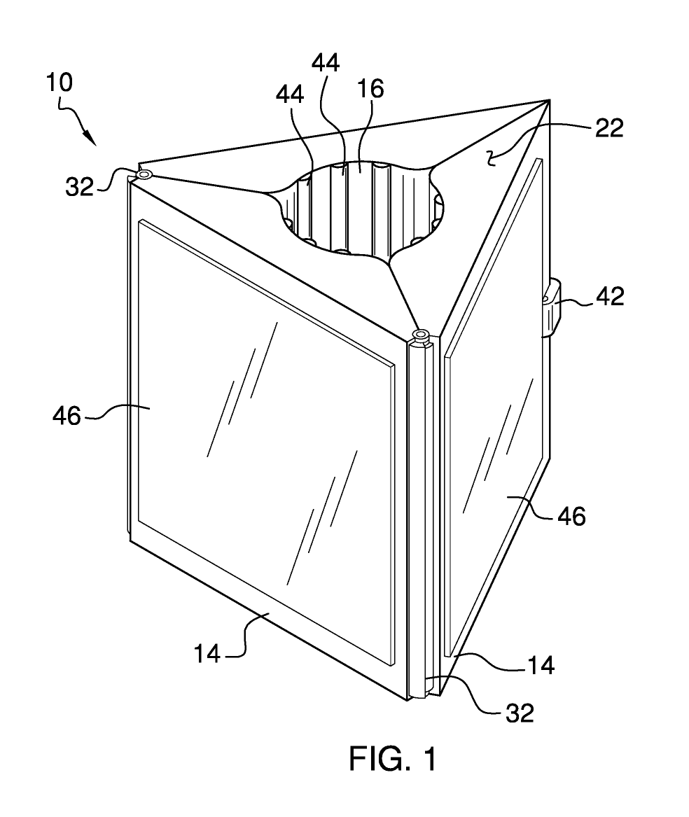

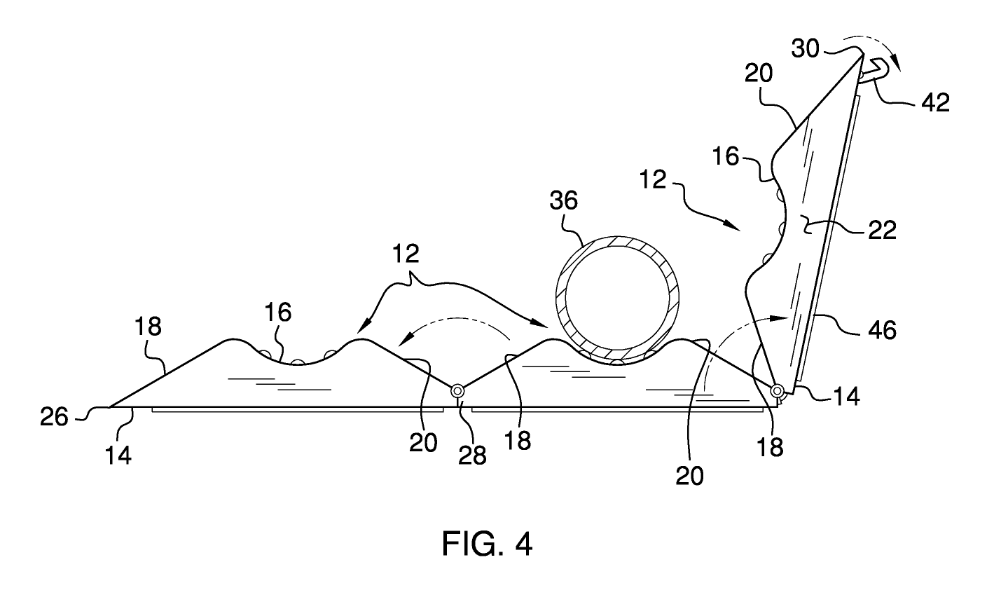

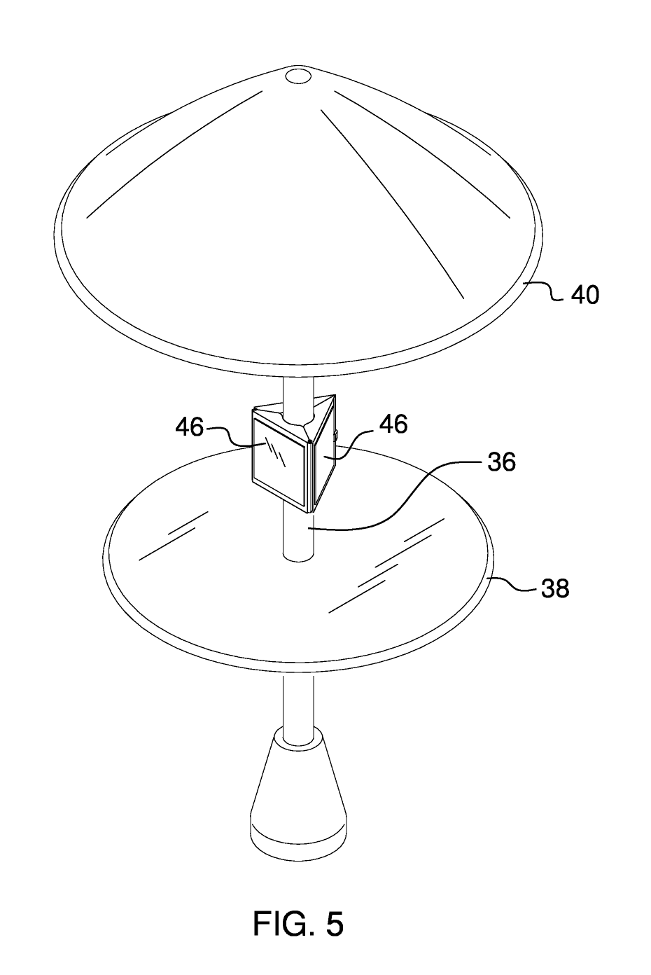

With reference now to the drawings, and in particular to FIGS. 1 through 5 thereof, a new display mount embodying the principles and concepts of an embodiment of the disclosure and generally designated by the reference numeral 10 will be described.

As best illustrated in FIGS. 1 through 5, the display mounting system 10 generally comprises a plurality of display mounts 12. Each of the display mounts 12 has an outer surface 14, an inner surface 16, a first side edge 18, a second side edge 20, a top side 22 and a bottom side 24. The display mounts 12 each comprise a resiliently compressible material such as an elastomer or a foamed elastomer. The display mounts 12 may be solely comprised of only the resiliently compressible material.

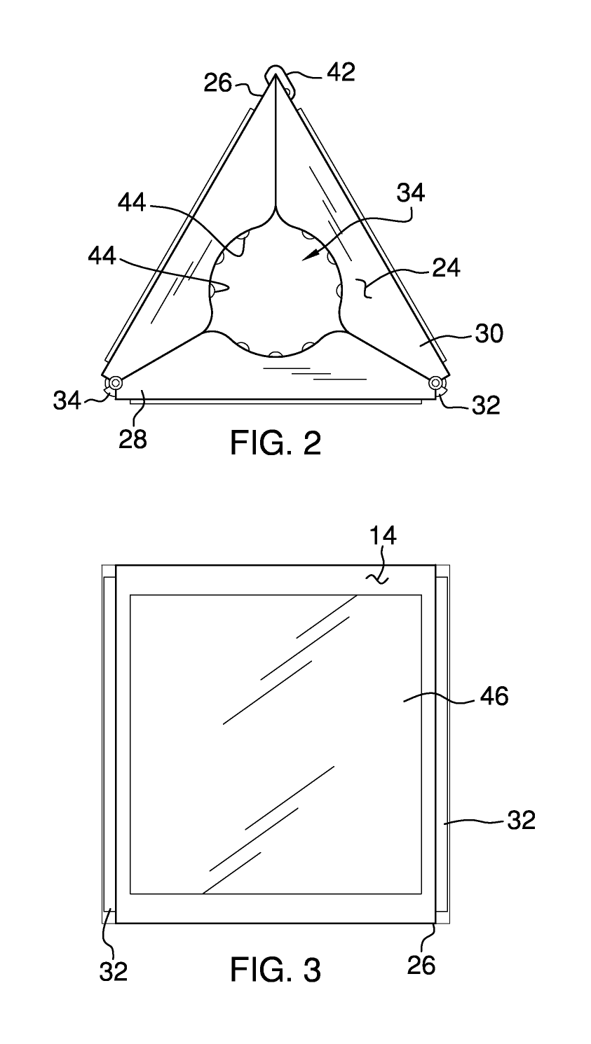

The plurality of the display mounts 12 may only include a first display mount 26, a second display mount 28 and a third display mount 30 pivotally coupled together with hinges 32 and positionable such that the inner surfaces 16 form a closed loop 34 configured to receive and frictionally engage a post 36. The post 36 may be any support post and in particular may include a post 36 extending through a table 38 and supporting a canopy 40. The second display mount 28 is positioned between the first 26 and third 30 display mounts. Each of the inner surfaces 16 may have a convexly arcuate shape so that when the closed loop 34 is formed it has an annular configuration to facilitate engagement with a cylindrical pole or post 36. Each of the first 18 and second 20 side edges of a corresponding one of the display mounts 12 tapers towards each other from associated ones of the outer surfaces 14 to associated ones of the inner surfaces 16. This forms an acute angle between the first 18 and second 20 side edges and the outer surface 14 so that they fit together to form a triangle as shown in FIG. 2.

A coupler 42 releasably couples the first side edge 18 of the first display mount 26 to the second side edge 20 of the third display mount 30. The coupler 42 may comprise any conventional closure assembly and as shown in the Figures may include a clasp hingedly coupled to the third display mount 30 which includes a catch that engages the first display mount 26 and extends around their abutting edges.

A plurality of ribs 44 may be provided such that each of the inner surfaces 16 has at least one of the ribs 44 thereon. The ribs 44 extend outwardly away from the inner surfaces 16 to frictionally engage the post 36. Each of the ribs 44 extends from the top side 22 to the bottom side 24 of an associated one of the display mounts 12. The ribs 44 may form a unitary structure with the display mounts 12 such that the ribs 44 and display mounts 12 are of one continuous, solid structure and as such the ribs 44 would also be comprised of a resiliently compressible material.

In use, displays 46 are attached to or extended into the outer surface 14 such that the displays 46 are easily visible when the display mounts 12 are mounted on the post 36 as stated above and as shown in FIG. 5. The displays 46 may be either signage or may include an electronic monitor for displaying a plurality of advertisements as is well known in the electronic advertising arts. Alternatively, the displays 46 may include sleeves for receiving inserts to allow the inserts to be removed and replaced as needed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A display mounting system configured to be positioned on a post, said system including:
a plurality of display mounts, each of said display mounts having an outer surface, an inner surface, a first side edge, a second side edge, a top side and a bottom side, said display mounts each comprising a resiliently compressible material, said plurality of said display mounts being pivotally coupled together and positionable such that said inner surfaces form a closed loop configured to receive and frictionally engage said post;
wherein and outer two of said display mounts is defined; and
a coupler releasably coupling said first side edge of said one of said outer two of said display mounts to said second side edge of the other one of said outer two of said display mounts.

2. The display mounting system according to claim 1, wherein said plurality of said display mounts includes a first display mount, a second display mount and a third display, wherein said second display mount is positioned between said first and third display mounts and said first and third display mounts define said outer two of said display mounts.

3. The display mounting system according to claim 1, wherein each of said inner surfaces has a convexly arcuate shape.

4. The display mounting system according to claim 2, wherein each of said inner surfaces has a convexly arcuate shape.

5. The display mounting system according to claim 4, wherein each of said first and second side edges of a corresponding one of said display mounts tapering towards each other from associated ones of said outer surfaces to associated ones of said inner surfaces.

6. The display mounting system according to claim 1, further including a plurality of ribs, each of said inner surfaces having at least one of said ribs thereon.

7. The display mounting system according to claim 6, wherein each of said ribs extends from said top side to said bottom side of an associated one of said display mounts.

8. The display mounting system according to claim 5, further including a plurality of ribs, each of said inner surfaces having at least one of said ribs thereon.

9. The display mounting system according to claim 8, wherein each of said ribs extends from said top side to said bottom side of an associated one of said display mounts.

10. A display mounting system configured to be positioned on a post, said system including:
a plurality of display mounts, each of said display mounts having an outer surface, an inner surface, a first side edge, a second side edge, a top side and a bottom side, said display mounts each comprising a resiliently compressible material, said plurality of said display mounts including a first display mount, a second display mount and a third display mount pivotally coupled together and positionable such that said inner surfaces form a closed loop configured to receive and frictionally engage said post, wherein said second display mount is positioned between said first and third display mounts, each of said inner surfaces having a convexly arcuate shape, each of said first and second side edges of a corresponding one of said display mounts tapering towards each other from associated ones of said outer surfaces to associated ones of said inner surfaces;
a coupler releasably coupling said first side edge of said first display mount to said second side edge of said third display mount; and
a plurality of ribs, each of said inner surfaces having at least one of said ribs thereon, each of said ribs extending from said top side to said bottom side of an associated one of said display mounts, said ribs forming a unitary structure with said display mounts.
